(19) United States
(12) Patent Application Publication
(10) Pub. No.: US 2019/0158724 A1
(43) Pub. Date: May 23, 2019

(54) NETWORK CAMERA WITH LOCAL CONTROL BUS

(71) Applicant: Seek Thermal, Inc., Goleta, CA (US)

(72) Inventors: William J. Parrish, Santa Barbara, CA (US); Blake Henry, Santa Barbara, CA (US)

(21) Appl. No.: 16/191,295

(22) Filed: Nov. 14, 2018

Related U.S. Application Data
(60) Provisional application No. 62/588,117, filed on Nov. 17, 2017.

(51) Int. Cl. H04N 5/232; H04N 5/247; H04L 29/08

(52) U.S. Cl. CPC H04N 5/23206; G08B 25/00; H04L 67/125; H04N 5/247

(57) ABSTRACT

System or methods for a camera module with local intelligence and a network connection to network servers, and in particular Internet servers. The camera module may include a visible light camera, a thermal imager, or both. The module may also include a local bus controller, which is standard bus compatible in both software and bus interface with an array of off-the-shelf actuators, sensors and other devices. Control and activation of these bus compatible devices may be either from the server or if desired for fast response, for emergency situations, or other reasons under the camera module control directly.

### INCORPORATION BY REFERENCE TO ANY PRIORITY APPLICATIONS

This application claims the benefit of U.S. Provisional Application Ser. No. 62/588,117, filed Nov. 17, 2017, entitled “NETWORK CAMERA WITH LOCAL CONTROL BUS,” which is hereby incorporated by reference in its entirety.

### BACKGROUND

### Field

The present application relates to cameras which are connected to a remote network server.

### Description of the Related Art

Networked smart camera modules and in particular dual spectrum cameras such as cameras with both a visible and thermal imager, are increasingly available in low cost compact forms suitable for a variety of monitoring and surveillance applications, with camera modules placed as desired and in communication with a networked server to form a monitoring system. Many applications for such systems may benefit from the camera modules with the ability to both observe and exert direct control over the local environment in a cost effective easy to implement manner.

### SUMMARY

Example embodiments described herein have innovative features, no single one of which is indispensable or solely responsible for their desirable attributes. Without limiting the scope of the claims, some of the advantageous features will now be summarized.

In some embodiments, system or methods may be provided for a camera module with local intelligence and a network connection to network servers and in particular Internet servers. The camera module may include a visible light camera, a thermal imager, or both. The module may also include a local bus controller, which is standard bus compatible in both software and bus interface with an array of off-the-shelf actuators, sensors and other devices. Control and activation of these bus compatible devices may be either from the server or if desired for fast response, for emergency situations, or other reasons under the camera module control directly.

In a first aspect, camera module may be provided, including: at least one camera; at least one local processor; at least one network connection to a network server; and, at least one standard local bus controller and interface, wherein; the camera, network connection and local bus controller are at least one of controlled by or implemented within the processor, and camera video acquisition and communication and control with devices connected to the local bus are shared between applications executing on the local processor and the network server.

In one embodiment of the first aspect, the network connection may be at least one of: at least one of a wired or wireless connection to a proprietary network; a wired connection to the Internet; or, a wireless connection to an internet bridge wherein the bridge comprises at least one of a wireless connection to a router which is in turn connected to an internet gateway or a wired connection to an internet gateway. In another embodiment of the first aspect, the network connection may be powered Ethernet. In one embodiment of the first aspect, the standard local bus may be at least one of, I²C, USB, PCI, or Firewire.

In another embodiment of the first aspect, the wireless network connection may include at least one of Bluetooth, Zigbee, wi-fi, cellular, satellite telephone, or optical. In one embodiment of the first aspect, there may be two cameras, a visible imager, and a thermal imager. In another embodiment of the first aspect, the bus controller and interface may include compatible with off-the-shelf devices including sensors and actuators.

In one embodiment of the first aspect, the off-the shelf devices may include; accelerometers, magnetic sensors, linear actuators, motors, A/D converters, barometers, fluid level sensors, current/power sensors, linear position sensors and actuators, flow sensors, pressure sensors, gas sensors, optical motion sensors, temperature sensors, optical position sensors, vibration/acoustic sensors, proximity sensors, audio alarms, visual alarms, visual status indicators, valve controllers, switch controllers, I/O breakout modules, and illumination controllers.

In another embodiment of the first aspect, the off-the-shelf devices may be under software control by means of at least one of commercially available drivers and scripts. In one embodiment of the first aspect, devices interfaced to the local bus may be accessible from at least one of applications executing on the local processor, applications executing on the server or both. In another embodiment of the first aspect, time critical control of devices interfaced to the local bus may be at least some times localized to the local processor module.

In another embodiment of the first aspect, time critical control may include local device action for local alarms, local equipment shutdown, local supply line shutdown, or direct local control of devices interfaced to the local bus. In one embodiment of the first aspect, at least some system controller functions may reside in one or more servers on the internet. In another embodiment of the first aspect, the server system controller functions may include messaging, data storage, data processing, and a web portal.

In one embodiment of the first aspect, environmental monitors from multiple users may interface with the server functions and each user accesses their environmental monitors and associated data through an account. In another embodiment of the first aspect, system operation protocol may include one or more of camera set-up, data processing protocol, alarm conditions, notification configuration, and data retrieval/display is accessed through the web portal server function. In one embodiment of the first aspect, notifications, including any alarm conditions, may be sent from the servers to users through one or more of email, text messages, telephone calls, or direct communication to user facility automation.

In another embodiment of the first aspect, data patterns and trends may be monitored over time by long term storage and analysis of monitor data. In one embodiment of the first aspect, the system may include a rechargeable battery, wherein the battery may be charged by one of a solar recharger or a local power charger.

In a second aspect, a method may be provided for operating an imaging and control module including at least one camera, at least one processor, at least one network interface and at least on local bus, the method including the steps of: connecting the camera to the network; receiving configuration and control information from at least one network server; reporting information related to camera image capture to the network server, connecting bus compatible local devices, including one or more sensors or actuators to the local bus; activating the local devices by at least one of local processor control, network server control, or both in response to information derived from the camera.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 schematically illustrates networked imaging system in accordance with an exemplary embodiment.

FIG. 2 schematically illustrates networked imaging system including visible imaging and thermal imaging in accordance with an exemplary embodiment.

FIG. 3 illustrates example off-the-shelf devices compatible with an exemplary local bus.

FIG. 4 is a flow chart illustrating a method of operating a networked imaging system in accordance with an exemplary embodiment.

FIG. 5 illustrates the various system elements including server functions of an exemplary embodiment.

### DETAILED DESCRIPTION

Generally described, aspects of the present disclosure describe a camera module, which may in some embodiments take advantage of advances in miniaturization and cost, and may be a relatively small, inexpensive device with minimal power requirements. Advantageously, the module may have processing power and storage allowing it to engage in a variety of image acquisition, image processing, and other control and acquisition actions. The camera module may have a network interface which allows it to reside on a network, either local, directly to the Internet, or through a local bridge to the Internet. Along with network servers, the camera module can execute applications that make one or more network cameras a network-connected system for monitoring, such as industrial, electrical, or environmental monitoring, or surveillance.

For some monitoring or surveillance applications, a camera module may observe conditions, which for a variety of safety or operational reasons may benefit from local response to information gathered by a camera module. For instance the module may include a thermal imager as well as a visible imager. The module may be placed in an area where operating machinery is observed. If undesirable thermal conditions such as dangerous temperatures are observed by the module, or evidence of catastrophic equipment failure is observed and processed by the intelligent module, it may be desirable for the module itself to take direct local action rather than simply communicate the observed condition to the network server.

So a degree of local control may be a desirable for an intelligent camera module. However, in keeping with the concept of low cost and ease of implementation, it may be desirable to utilize the local module intelligence to control a standardized bus, such as USB, I²C, or the like. Such a local control bus may be advantageous as an array of compatible devices are available off-the-shelf, as well as easy to implement software drivers for these compatible devices. Adding a standard local bus to a camera module may provide direct access to a range of sensors and actuators, enabling actions such as local audio and/or visual alarms, direct control of shut off or turn on of equipment and/or safety equipment, and the like. Advantageously, such local control could be initiated directly through the module by the server, or if desired or necessary, directly by the module local processor. The elements of network connectivity, local intelligence and a local control bus, may provide an extremely powerful system for monitoring and surveillance with an enhanced level of safety and operational efficiency for the environments in which the camera module systems are utilized.

The camera modules may include local processor systems which in turn may include computer methods including programs or applications or digital logic methods and may be implemented using any of a variety of analog and/or digital discrete circuit components (transistors, resistors, capacitors, inductors, diodes, etc.), programmable logic, microprocessors, microcontrollers, application-specific integrated circuits, or other circuit elements. A memory may be configured to store computer programs and may be implemented along with discrete circuit components to carry out one or more of the processes described herein. The modules may include one or more imagers including imaging sensors which may be a Focal Plane Array (FPA), which may be part of a camera core for a visible, thermal, or other imaging device. Some processing and memory components may be included in the camera module and others may reside on other separate computerized devices including other modules, smart phones, tablets and computers or any combination thereof. In other embodiments some processing and memory elements may be implemented using programmable logic, such as an FPGA, which are part of the core, module, or camera system. The modules and the computerized devices may communicate over a network, including wireless networks.

In some embodiments, image data may be provided by a thermal imaging sensor, which may include a Focal Plane Array (FPA) imaging sensor. An example of such a system is an infrared (IR) camera core, including an IR FPA and associated optics and electronics.

An FPA, visible, thermal or other, typically includes a two dimensional array of pixels including X by Y photodetectors, which can provide a two-dimensional image of a scene. For imaging purposes, image frames, typically data from all or some of the detectors (frame or subframe), up to X*Y pixels per frame, are produced by the FPA, with each successive frame containing data from the array captured, and typically converted from analog to digital form, in successive time windows. Thus, a frame (or subframe) of data delivered by the FPA will consist of a number of digital words, representing each pixel in the image, e.g., data from each detector. These digital words are usually the length of the analog to digital (A/D) conversion process, for example if the pixel data is converted with a 14 bit A/D, the pixel words are 14 bits in length, and there would be 16384 (2¹⁴) counts per word. For an IR camera used as a thermal imaging system, these words may correspond to a map of intensity of radiation in a scene measured by each pixel in the array. The intensity per pixel for a micro-bolometer type of photodetector IR FPA, for example, usually corresponds to the temperature of the corresponding part of the scene, with lower values corresponding to colder regions and higher values to hotter regions. It may be desirable to display this data on a visual display as an image of relative temperature vs position, or otherwise process and use the temperature information.

Each pixel in a thermal FPA may include the radiation detector itself, which for an IR imaging array may generate relatively small signals in response to the detected radiation. Pixels may include interface circuitry including resistor networks, transistors, and capacitors on a Readout Integrated Circuit (ROIC) that may be directly interfaced to the array of detectors. For instance, a microbolometer detector array, which is a MEMS (Microelectrical Mechanical System) construct may be manufactured using a MEMS process building up the microbolometers onto an ROIC which is fabricated using electronic circuit fabrication techniques. When complete the ROIC with the micro-bolometers integrated onto it combine to form an FPA.

Visible imaging sensors are more common and familiar to camera designers, and will not be described in detail here. Small low power high performance visible imagers such as those found in smartphones and tablets for instance would be a suitable choice as imagers for a low cost camera module

A camera module may be formed from one or more FPA's, with associated electronics and optics, processing logic, and a wireless interface. A camera module based monitoring system may be formed including one or more such modules along with one or more computerized devices acting as servers on a network executing suitable programs or applications and/or digital logic, and interfaced to the modules across one or more wired or wireless networks.

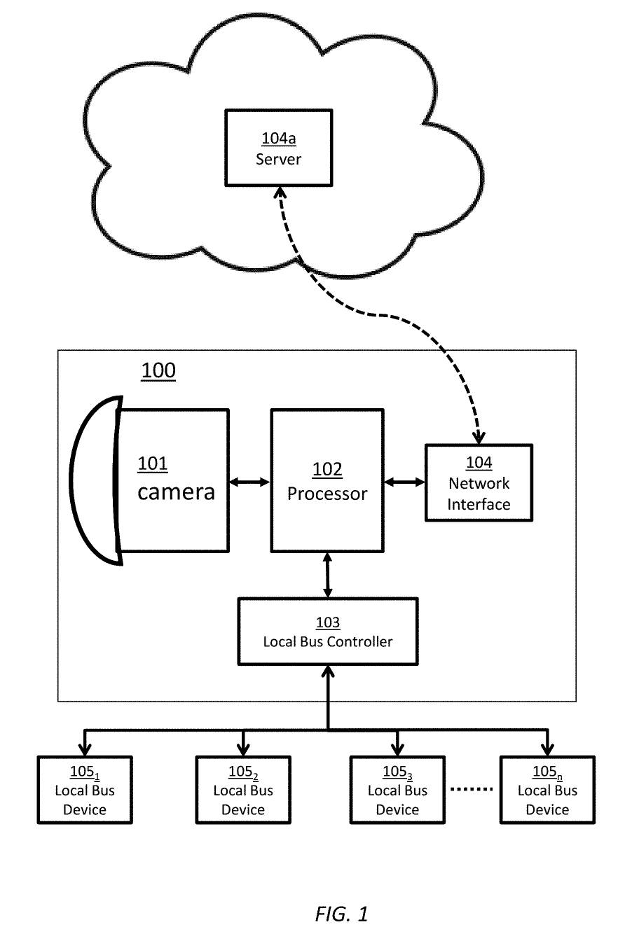

Referring to FIG. 1, a general block diagram of an illustrative embodiment of a camera module 100 is shown. Camera module 100 is in communication with a processor 102. Processor 102 is in communication with a network interface 104 and a local standardized bus controller 103. Although the elements are shown separately, in some embodiments they may be executed in software within the processor as opposed to separate physical entities.

Processor 102 may be functionally distributed over multiple elements, such as microprocessors, FPGA's, etc., each handling a different portion of the image processing, sequencing, and communication tasks.

To form a system, camera module 100 is networked to one or more servers 104a, which may reside on a local network and/or the Internet. The network interface may be wired or wireless. Example interfaces include Bluetooth, Zigbee, wi-fi, cellular, satellite telephone, optical, etc., or any combination. Wired interfaces include Ethernet, USB, Firewire, and others. The module may also connect to a broader network through a local bridge, such as a Wi-Fi router or other network bridge. In a particular embodiment, the network connection may be powered Ethernet, and the module could be powered directly from the network connector.

In other embodiments Module 100 may be battery powered, or it may derive power from its installation other than through the network connection. A battery powered module 100 with a wireless network interface may be advantageous, as it allows for modules to be placed in a space with minimal or no infrastructure changes to the environment, by simply attaching the modules through a variety of simple means, where desired, with no need for any additional power, wiring, or other infrastructure support. Powered Ethernet is also common, and unpowered Ethernet, which is ubiquitous, may be easily converted to powered Ethernet with power modules which are easy to install. Thus, such camera modules in many forms may be conveniently installed in an existing environment with little to no site preparation or modification.

The local bus controller 103 can be a standard bus with a large selection of compatible devices as well as available software drivers for the devices. The standard local bus may include, I²C, USB, PCI, Firewire, or others. As shown a plurality of local devices 105₁, 105₂, 105₃, . . . 105ₙ may reside on the bus.

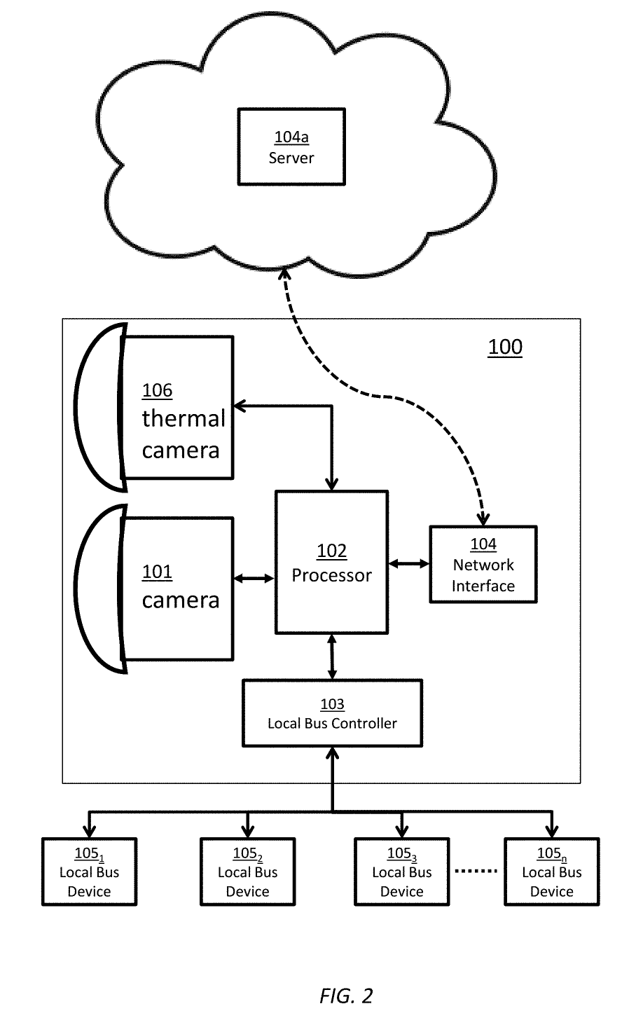

FIG. 2 illustrates a system similar to the system of FIG. 1. In the system of FIG. 2, the camera module 100 is a dual imaging system including a thermal camera 106. Additionally, any one or combination of imaging types are possible.

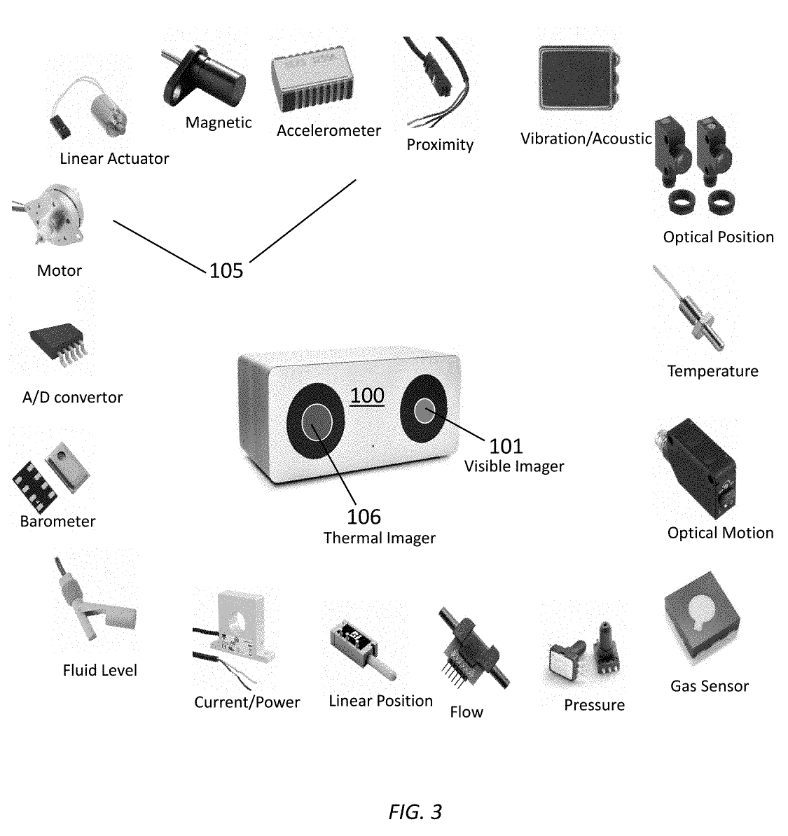

FIG. 3 illustrates a module 100 with both a thermal imager 106 and a visible imager 101. An assortment of devices available in particular on the I²C bus are shown. Other buses have similar device compatibility Devices suitable for monitoring and surveillance applications may include accelerometers, magnetic sensors, linear actuators, motors, A/D converters, barometers, fluid level sensors, current/power sensors, linear position sensors and actuators, flow sensors, pressure sensors, gas sensors, optical motion sensors, temperature sensors, optical position sensors, vibration/acoustic sensors, proximity sensors, audio alarms, visual alarms, visual status indicators, valve controllers, switch controllers, I/O breakout modules, illumination controllers, and others. Any or all of these may be available on the I²C bus. I²C may be advantageous due to its simplicity and the large number of very low cost compatible devices, some of which may cost just a few dollars or less, available device drivers, and industrial suitability of many of the devices. For many applications, e.g., closing valves, turning on warning lights, monitoring local humidity, and the like, high bus speeds such as can be achieved with buses like USB may not be critical, and relatively low speed busses like I²C may be perfectly suitable.

In one example, the camera module 100 includes thermal imaging, is networked through powered Ethernet, and includes and acts as an I²C master. This module can be compact and inexpensive, utilizing a modern low cost microbolometer thermal imager, and is very easy to install and connect to in most industrial environments. For example as a monitor in a machinery room environment, the modules could be placed to observe various machines, piping and electrical cabinets/wiring, and the like. Off-the-shelf bus compatible valves, electrical switches, and visible/audio alarms could be connected to the bus. If a dangerous temperature condition is observed and captured by the camera module, it could directly initiate shut-off and local alarm actions, either under its own processor control or by the server through the camera module. The result is the camera module may serve as both watchdog and industrial controller, and by way of the standard local bus accomplishes both functions in a cost effective, easy to implement manner.

Other examples include intruder alert and/or interdiction, electrical cabinet monitoring and many other applications where the image acquisition and analysis resides in one unit with standardized local control

The server may be remote as long as it is reachable over a network. In fact the camera modules could be configured to report to and receive instructions from a cloud based server. This would allow for modules anywhere in the world to be accessed from anywhere in the world. It would also allow for use of the modules to be handled as a subscription service where the modules report to the cloud, data from multiple installations is handled at the cloud level and deviations are reported over various networks, such as email alerts, text messages, and the like.

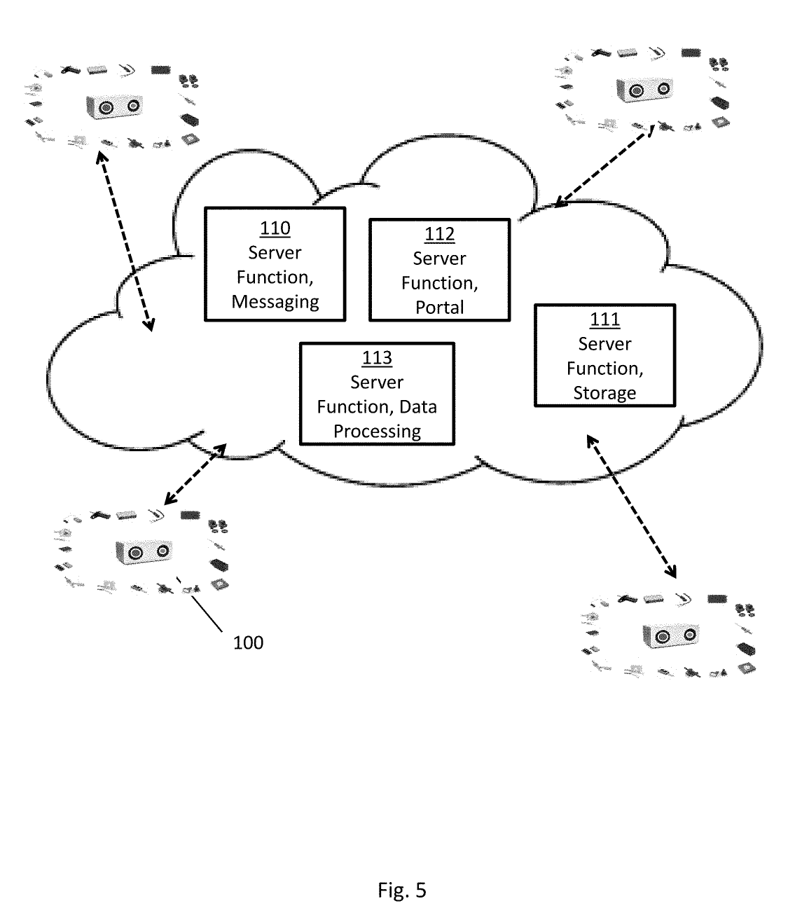

Such a system is shown in FIG. 5 where modules 100 with associated local devices interface over a network to network servers, which implement the various system functions 110 to 113.

Any physical layer may be used to access the network, including wi-fi, Ethernet, local networks such as Bluetooth, Zigbee and the like, cellular communication, microwave communication, IR communication, satellite phone, and others. The connection can be direct to the network, or through a local bridge or relay, as long as each module has a gateway to the network. The network may be proprietary network, but for many embodiments it is envisioned that the network will be the internet. The system controller functions described above may be apportioned across one or more servers implementing server functions.

In some embodiments, camera modules belonging to individual users installed at a variety of sites and/or locations may all interface to the server based control system. Each user may access their individual modules and the data acquired from their monitors through an account based system.

Example server functions are shown in FIG. 5. Messaging 110 handles module communication and commands, identifying each module on the network and directing two-way messaging between the module, the module owner, and the other server functions. Module data acquired may be stored on the network (e.g., cloud storage) allowing for the ability to store data representing long periods of time. Such long-term storage and access allows for the possibility of identifying trends and patterns, and in particular thermal patterns that indicate potential failure or other abnormal condition of an item the monitors are observing. In fact, the system can be configured to observe and correlate thermal patterns for similar devices from multiple users to build up learning of thermal signatures and patterns that correlate to failure conditions, which may benefit all users of the system.

Data processing 113 may also take place at the server level, again distributed over all monitors interface to the network.

A portal 112 is an important piece of the system. The portal is the user interface and allows for set-up and access to data for users, including scripts or drivers for the local bus devices. For instance the portal is where the user can identify the location of each module in his installation, set-up parameter such as image regions and thresholds for each region, implement trending routines, and define protocols for data storage, processing and reporting, such as what kind of data, such as region temperature, whole images or real time imaging happens in response to specified conditions. The portal is also where the user can specify how notifications of alarm or other conditions of interest will be communicated, and under what conditions the camera module will take direct action over the local bus. Having the system controller functionality at the internet level offers a wide variety of communications possibilities. Emails, text messages, and phone calls are all possible as well as communication to any networked entity such as user on-site automation (factory controllers or individual networked devices). It is possible that if an over-temperature condition is observed for a piece of networked equipment (process equipment, motor, pump or many other types) any or all of a text message could be sent to appropriate users, a factory controller could be notified and the individual device's warning system (Christmas tree lighting, audio alarm, etc.) could be activated. Or if necessary, act to perform these actions through local bus connected devices either directly or originating at the server and passed through to the local bus. All of the set-up can be customized and personalized on a per module basis.

Also, cameras may not necessarily be used solely in fixed installations. Thermal monitoring may apply to moving installations such as vehicles (cars, trucks aircraft, etc.) or large mobile equipment such as construction or mining vehicles, or be transported, e.g., mounted to vehicles or carried, to observation location areas. Thus a GPS device may also be advantageously included in a camera module.

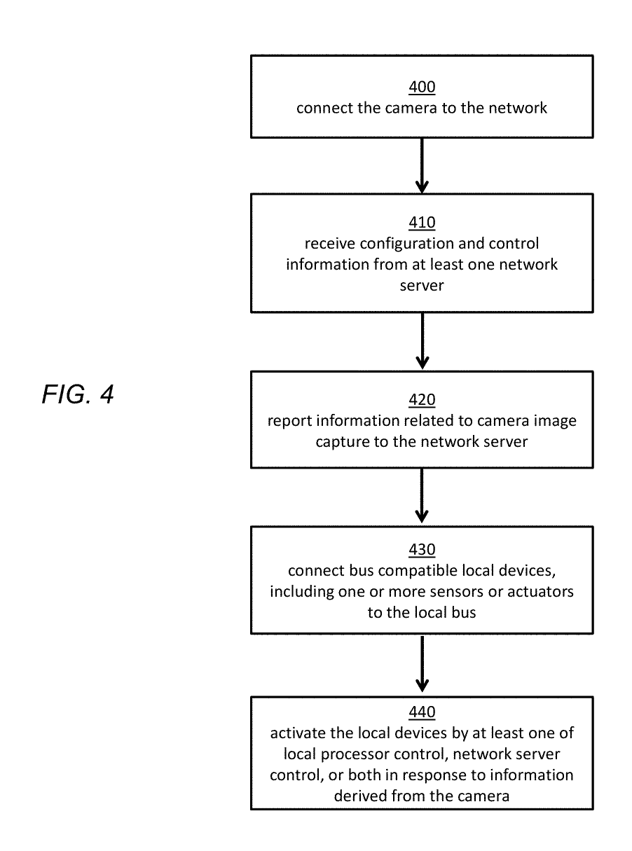

An example method utilizing a camera module of the type disclosed herein is shown in FIG. 4. In step 400 the camera module is connected to the network. This could be a local network and/or the Internet, a wired or wireless connection and either direct or through a bridge or gateway device such as a Wi-Fi router connected to network modem.

In step 410 configuration and control information is received from one or more network servers. This configuration information could relate to camera image acquisition parameter for example such as set-up of temperature thresholds if the camera has thermal imaging capability.

In step 420 information related to camera image acquisition may be reported to the servers. For example motion detected analyzed as an intruder, other pattern related discrepancies are the type of results an intelligent camera module can obtain from acquired and processed image data.

In step 430 local bus compatible devices including one or more sensors and actuators are connected to the camera local standard bus. Selection of a suitable local bus for the camera module may provide for a large number of useful devices that can quickly and easily integrated from both a hardware and software point of view.

In step 440 the local bus devices are activated by the camera processor, the servers or both in response to image information derived from the camera. For instance a dangerously high temperature detected by a thermal imaging camera could trigger the local activation of shut-off switches/valves, warning signal indicators, and the like all from local bus compatible devices hooked up to the module.

The embodiments described herein are exemplary. Modifications, rearrangements, substitute devices, processes, etc. may be made to these embodiments and still be encompassed within the teachings set forth herein. One or more of the steps, processes, or methods described herein may be carried out by one or more processing and/or digital devices, suitably programmed. One or more of the electronic, optical, and other system components may be replaced with alternate elements.

Depending on the embodiment, certain acts, events, or functions of any of the processes described herein can be performed in a different sequence, can be added, merged, or left out altogether (e.g., not all described acts or events are necessary for the practice of the process). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and method steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processor configured with specific instructions, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. For example, the configuration data described herein may be implemented using a discrete memory chip, a portion of memory in a microprocessor, flash, EPROM, or other types of memory.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. A software module can comprise computer-executable instructions which cause a hardware processor to execute the computer-executable instructions.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to illustrative embodiments, it will be understood that various omissions, substitutions, and changes in the form and details of the devices or processes illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A camera module comprising;
a camera;
a local processor in communication with the camera;
a network connection in communication with the processor and configured to communicate with a remote server; and
a standard local bus comprising a bus controller and a bus interface,
wherein the camera, the network connection, and the bus controller are controlled by or implemented within the processor, and
wherein the local processor and the remote server execute applications configured to share, between the local processor and the remote server, acquisition of camera video data from the camera, communication with devices connected to the local bus, and control of devices connected to the local bus.

2. The camera module of claim 1 wherein the network connection comprises at least one of:
a wired or wireless connection to a proprietary network;
a wired connection to the Internet; or
a wireless connection to an internet bridge, wherein the internet bridge comprises at least one of a wired connection to an internet gateway or a wireless connection to a router, the router being connected to an internet gateway.

3. The camera module of claim 2, wherein the network connection comprises a powered Ethernet connection.

4. The camera module of claim 1, wherein the standard local bus comprises at least one of I²C, USB, PCI, or Firewire.

5. The camera module of claim 1, wherein the network connection includes at least one of Bluetooth, Zigbee, wi-fi, cellular, satellite telephone, or optical.

6. The camera module of claim 1, wherein the camera comprises a visible imager and a thermal imager.

7. The camera module of claim 1, wherein the bus controller and the bus interface are compatible with off-the-shelf devices including sensors and actuators.

8. The camera module of claim 7, wherein the off-the shelf devices include: accelerometers, magnetic sensors, linear actuators, motors, A/D converters, barometers, fluid level sensors, current/power sensors, linear position sensors and actuators, flow sensors, pressure sensors, gas sensors, optical motion sensors, temperature sensors, optical position sensors, vibration/acoustic sensors, proximity sensors, audio alarms, visual alarms, visual status indicators, valve controllers, switch controllers, I/O breakout modules, and illumination controllers.

9. The camera module of claim 7, wherein the off-the-shelf devices are under software control by one or more commercially available drivers or scripts.

10. The camera module of claim 1, wherein devices interfaced to the local bus are accessible from applications executing on at least one of the local processor or the server.

11. The camera module of claim 10, wherein the applications are configured to localize, to the local processor, at least a portion of time critical control of devices interfaced to the local bus.

12. The camera module of claim 11, wherein time critical control includes local device action for local alarms, local equipment shutdown, local supply line shutdown, or direct local control of devices interfaced to the local bus.

13. The camera module of claim 1, wherein at least some system controller functions reside in the remote server.

14. The camera module of claim 13, wherein the remote server system controller functions include messaging, data storage, data processing, or a web portal.

15. The camera module of claim 14, wherein the remote server system controller functions include a web portal, and wherein system operation protocol, including at least one of camera set-up, data processing protocol, alarm conditions, notification configuration, or data retrieval/display, is accessed through the web portal.

16. The camera module of claim 13, wherein environmental monitors associated with a plurality of users interface with the remote server system controller functions, and wherein each of the environmental monitors and associated data is accessible to the associated user through an account.

17. The camera module of claim 13, wherein notifications, including any alarm conditions, are sent from the remote server to users through at least one of email, text messages, telephone calls, or direct communication to user facility automation.

18. The camera module of claim 13, wherein data patterns and trends are monitored over time by long term storage and analysis of monitor data.

19. The camera module of claim 1, further comprising a rechargeable battery, wherein the battery is configured to be charged by a solar recharger or a local power charger.

20. A method for operating an imaging and control module comprising a camera, a processor, a network interface, and a local bus, the method comprising:
connecting the camera to a remote server via the network interface;
receiving configuration and control information from the remote server;
reporting information related to camera image capture to the remote server;
connecting at least one bus compatible local device, including one or more sensors or actuators, to the local bus; and
responsive to receiving information from the camera, activating the at least one local device by at least one of local processor control or network server control.
